(19) United States
(12) Patent Application Publication
(10) Pub. No.: US 2020/0181451 A1
(43) Pub. Date: Jun. 11, 2020

(54) LOW VOC WATER-BORNE UV CURABLE SINGLE-LAYER COATING COMPOSITION, METHOD OF APPLYING THE SAME, AND SUBSTRATE COATED THEREWITH

(71) Applicant: PPG Coatings (Tianjin) Co., Ltd., Tianjin (CN)

(72) Inventors: Fuzhang Su, Suzhou (CN); Haifeng Liu, Suzhou (CN); Zhengsong Luo, Suzhou (CN)

(73) Assignee: PPG Coatings (Tianjin) Co., Ltd., Tianjin (CN)

(21) Appl. No.: 16/641,386

(22) PCT Filed: Aug. 23, 2018
(86) PCT No.: PCT/CN2018/101913

§ 371 Date: Feb. 24, 2020

(30) Foreign Application Priority Data
Aug. 24, 2017 (CN) 201710737163.1

(51) Int. Cl. C09D 175/06; C08G 18/44; C08G 18/73; C08K 5/06; C08L 75/06; C08L 33/08; C08L 33/10

(52) U.S. Cl. CPC C09D 175/06; C08G 18/44; C08G 18/73; C08K 5/06; C08L 75/06; C08L 2312/06; C08L 33/10; C08L 2201/54; C08L 2203/16; C08L 2203/20; C08L 2205/02; C08L 33/08

(57) ABSTRACT

Provided is a low VOC water-borne UV curable single-layer coating composition, comprising a carbonate-based polyurethane resin and a nonionic HDI type polyurethane-acrylate resin. Also provided are a method of applying the coating composition, and the substrate coated therewith.

### FIELD OF INVENTION

The present invention relates to a water-borne UV curable coating composition having a low VOC content, and in particular to a water-borne UV curable coating composition comprising a carbonate-based polyurethane resin and a nonionic HDI type polyurethane-acrylate resin. The present invention further relates to a method of coating a substrate with the water-borne UV curable coating composition and the substrate coated therewith.

### BACKGROUND OF INVENTION

In the 3C coatings including computer, communication and consumer electronics coatings, few water-borne UV curable single-layer paints are useful for a plastic substrate including polycarbonate (PC), polycarbonate+acrylonitrile/butadiene/styrene copolymer (PC+ABS), polycarbonate+carbon fiber (PC+CF), and polycarbonate+glass fiber (PC+GF). Such water-borne UV curable single-layer paints also have disadvantages such as poor adhesion, abrasion resistance and performance and appearance after water boiling. Therefore, there is currently a need for a water-borne UV curable single-layer coating composition having reduced VOC content and capable of meeting various of the above property requirements.

### SUMMARY OF INVENTION

The present invention provides a low VOC water-borne UV curable single-layer coating composition, comprising a carbonate-based polyurethane resin and a nonionic HDI type polyurethane-acrylate resin.

The present invention also provides a method for forming a coating on a substrate, comprising applying a low VOC water-borne UV curable single-layer coating composition to at least a portion of the substrate, wherein the low VOC water-borne UV curable single-layer coating composition comprises a carbonate-based polyurethane resin and a nonionic HDI type polyurethane-acrylate resin.

The present invention also provides a coated substrate, comprising a substrate and a low VOC water-borne UV curable single-layer coating composition deposited on at least a portion of the substrate, wherein the low VOC water-borne UV curable single-layer coating composition comprises a carbonate-based polyurethane resin and a nonionic HDI type polyurethane-acrylate resin.

### BRIEF DESCRIPTION OF THE DRAWINGS

FIGS. 1A-1D shows schematic peeling of coating after being subjected to an adhesion testing on a PC substrate.

### DETAILED DESCRIPTION

Other than in any operating examples, or where otherwise indicated, all numbers expressing, for example, quantities of ingredients used in the specification and claims, are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in the description and appended claim, the articles “a”, “an”, and “the” include plural references, unless specifically stated as one reference.

As used herein, the weight average molecular weight (Mw) of a polymer is determined by a gel permeation chromatography using an appropriate standard such as a polystyrene standard.

The present invention is directed to providing a low VOC single-layer water-borne coating compositon useful for coating a plastic substrate such as PC, PC+ABS, PC+CF, PC+GF and the like, which coating composition is UV curable. The UV curing has advantages such as short curing time, simple equipment, high energy utilization and no harm to environment, and therefore it is widely used for rapid curing of coatings, printing inks, crosslinking agents, and structural materials, and it is especially suitable for the surface coating of electronic consumer products.

As used herein, the term “water-borne” refers to a coating composition including at least water in an amount of more than 50 wt %, based on the total solvent weight in the composition.

As used herein, the term “low VOC” refers to a coating composition having a VOC content lower than 420 g/L (23° C., atmospheric pressure, 101.3 kPa). Preferably, the water-borne UV curable single-layer coating composition in the present invention has a VOC content (calculated without water) in the range of 100-250 g/L.

In terms of the present invention, the term “volatile organic compound (VOC)” refers to any organic compound having a boiling point less than or equal to 250° C. (482° F.) measured at a standard atmospheric pressure of 101.3 kPa. Organic solvents are a typical source for VOC.

The water-borne UV curable single-layer coating composition according to the present invention comprises a carbonate-based polyurethane resin and a nonionic HDI type polyurethane-acrylate resin.

In the coating composition, the carbonate-based polyurethane resin is a water-borne polyurethane resin modified by polycarbonate. Typically, for preparing the coating composition of the present invention, the carbonate-based polyurethane is used in form of a dispersion having a solid content of about 30-40%, such as a solid content of about 35% (by weight). The carbonated-based polyurethane resin comprises 45-65 wt %, preferably 50-60 wt %, and more preferably 53-57 wt % of polycarbonate in the carbonate-based polyurethane resin. The carbonate-based polyurethane resin has a viscosity of about 50 to 500 cp at a temperature of 25° C. The viscosity is measured using a Brookfield RVT viscometer, with a No. 3 spindle, at speed of 100 rpm, and a temperature of 25° C.

Typically, the carbonate-based polyurethane resin is present in the coating composition in an amount of about 20-25 wt %, based on the weight of the coating composition. When the amount of the resin is out of the range, the adhesion after recoating as defined below might deteriorate.

Many commercially available polyurethane resins can be used in the present invention. For instance, examples of such resins that can be used in the present invention include, but are not limited to Hauthane L-3685 from Hauthaway.

In the coating composition, the nonionic HDI type polyurethane-acrylate resin is a water-borne polyurethane resin modified by acrylate and/or a mixture of urethane resin and acrylate compounds. The term “HDI” is short for hexamethylene diisocyanate. The nonionic HDI type polyurethane-acrylate used herein is synthetized from materials containing hexamethylene diisocyanate (HDI). Typically, for preparing the coating composition of the present invention, the nonionic HDI type polyurethane-acrylate resin is used in form of a dispersion having a solid content of about 45-55%, such as a solid content of about 50% (by weight). The nonionic HDI type polyurethane-acrylate resin comprises 48-67 wt %, preferably 50-65 wt %, more preferably 53-61 wt % of acrylate compounds in the nonionic HDI type polyurethane-acrylate resin. The nonionic HDI type polyurethane-acrylate resin has a weight average molecular weight of from about 500 to 4000 and preferably from about 1000 to 3000, as determined by gel permeation chromatography using polystyrene standard, which imparts excellent abrasion resistance and water-boiling resistance to the coating composition of the present invention. The nonionic HDI type polyurethane-acrylate resin further has a glass transition temperature of from about 120 to 180° C. and preferably from about 140 to 160° C. The glass transition temperature is determined by Dynamic Mechanical Analysis (DMA) using a TA Instruments Q800 apparatus with a frequency of 10 Hz, an amplitude of 5 mm, and a temperature ramp of −100° C. to 250° C., with the Tg identified as the peak of tan δ curve according to ASTM D7028.

Typically, the nonionic HDI type polyurethane-acrylate resin is present in the coating composition in an amount of about 10-15 wt % based on the weight of the coating composition. When the amount of the polyurethane-acrylate resin is less than 10 wt %, the coating formed from the coating composition might deteriorate in water-boiling resistance property. When the amount of the resin is greater than 15 wt %, the coating formed from the coating composition might deteriorate in hardness.

Many commercially available nonionic HDI type polyurethane-acrylate resins can be used in the present invention. For example, examples of such resins that can be used in the present invention include, but are not limited to OLESTER™ RA7011 from Mitsui Chemicals, Inc.

The water-borne low VOC UV curable single-layer coating composition according to the present invention further comprises 1-3 wt % of a photoinitiator based on the weight of the coating composition. There is no particular limitation to the photoinitiator used, as long as it can decompose to generate free radicals upon exposure to light radiation and initiate a photopolymerization reaction. Available photoinitiators include, but are not limited to compounds comprising a benzoin moiety, compounds comprising a benzil ketal moiety, dialkoxy acetophenone, α-hydroxyalkylphenylketone, α-aminealkylphenylketone, acyl phosphine hydride, esterified oxime ketone compounds, aryl peroxide ester compounds, halo methyl aryl ketone, organic sulphur-containing compounds, benzoylformate, and the like. Two or more photoinitiators may be selected as needed.

Many commercially available photoinitiators can be used in the present invention. For example, examples of such photoinitiators that can be used in the present invention include, but are not limited to, 819DW from IRGACURE, 2959 from IRGACURE, 184/TPO/BP/MBF from Ciba, KIP160 from IGM, and any combination thereof.

The water-borne low VOC UV curable single-layer coating composition according to the present invention comprises about 45-60 wt % of water. The water-borne low VOC UV curable single-layer coating composition according to the present invention further comprises an co-solvent. There is no specific limitation to the solvent used, which can be any of organic solvents known by those skilled in the art and which includes, without limitation, an aliphatic or aromatic hydrocarbon such as Solvesso 100TM, an alcohol such as butanol, isopropanol or 2-butoxyethanol, an ester such as ethyl acetate, butyl acetate or iso-butyl acetate, a ketone such as acetone, methyl isobutyl ketone or methyl ethyl ketone, an ether, an ether-alcohol or an ether ester such as ethyl 3-ethoxypropionate, or a mixture of any of the aforesaid. The solvent is usually present in an amount of 5-15 wt % of the coating composition.

The water-borne low VOC UV curable single-layer coating composition according to the present invention further may comprise one or more other additives, which include, but are not limited to a wetting agent, a dispersant, a pH modifier, a pigmented filler, a deforming agent, a rheological agent, and the like. The types of these additives are well-known by those skilled in the art and the amount thereof will be easily determined by those skilled in the art as needed.

The water-borne low VOC UV curable single-layer coating composition according to the present invention may be applied onto at least a portion of the substrate by known techniques in the art, which for example comprise spraying, rolling, curtain coating, dipping/immersion, brushing, or flow coating. Then, the resulting coating film is subjected to a UV curing, which may for example be achieved by baking at 60-80° C. for 10-15 min to evaporate the solvent and water, followed by UV irradiating at UV energy of 700-900 mJ/cm² and light intensity of 100-300 mW/cm². The film thickness of the coating is usually in the range of 15 to 20 μm.

The water-borne low VOC UV curable single-layer coating composition according to the present invention may be applied to any substrate. Said substrates may include, but are not limited to ceramics, woods, leathers, stones, glass, alloy, paper, plastics, fiber, cotton textiles, and the like, and preferably comprises plastic substrates. The plastic substrates particularly refer to an electronic display of an electronic product, such as a vehicle display screen, a mobile phone and a computer. The plastic substrate may be prepared from polycarbonate (PC), polycarbonate+acrylonitrile/butadiene/styrene copolymer (PC+ABS), polycarbonate+carbon fiber (PC+CF), or polycarbonate+glass fiber (PC+GF).

The following numbered clauses summarizs some aspects of the invention:

1. A water-borne UV curable single-layer coating composition, comprising a carbonate-based polyurethane resin and a nonionic HDI type polyurethane-acrylate resin.

2. The water-borne UV curable single-layer coating composition of aspect 1, wherein the carbonate-based polyurethane resin comprises 45-65 wt % polycarbonate in the carbonate-based polyurethane resin.

3. The water-borne UV curable single-layer coating composition of any one of the preceding aspects, wherein the carbonate-based polyurethane resin has a viscosity of about 50 to 500 cp at a temperature of 25° C.

4. The water-borne UV curable single-layer coating composition of any one of the preceding aspects, wherein the carbonate-based polyurethane resin comprises 20-25 wt % of the total weight of the coating composition.

5. The water-borne UV curable single-layer coating composition of any one of the preceding aspects, wherein the nonionic HDI type polyurethane-acrylate resin comprises 48-67 wt % of acrylate compounds in the nonionic HDI type polyurethane-acrylate resin.

6. The water-borne UV curable single-layer coating composition of any one of the preceding aspects, wherein the nonionic HDI type polyurethane-acrylate resin has a weight average molecular weight of from about 500 to 4000.

7. The water-borne UV curable single-layer coating composition of any one of the preceding aspects, wherein the nonionic HDI type polyurethane-acrylate resin has a glass transition temperature of from about 120 to 180° C.

8. The water-borne UV curable single-layer coating composition of any one of the preceding aspects, wherein the nonionic HDI type polyurethane-acrylate resin comprises 10-15 wt % of the total weight of the coating compostion.

9. The water-borne UV curable single-layer coating composition of any of the preceding aspects, having a VOC content of less than 420 g/L.

10. The water-borne UV curable single-layer coating composition of aspect 9, having a

VOC content in the range of 100-250 g/L.

11. A method for forming a coating on a substrate, comprising applying a water-borne UV curable single-layer coating composition to at least a portion of the substrate, wherein the water-borne UV curable single-layer coating composition comprises a carbonate-based polyurethane resin and a nonionic HDI type polyurethane-acrylate resin.

12. The method of aspect 11, wherein the water-borne UV curable single-layer coating composition is the coating composition of any one of aspects 1 to 10.

13. A coated substrate, comprising a substrate and a water-borne UV curable single-layer coating composition deposited on at least a portion of the substrate, wherein the water-borne UV curable single-layer coating composition comprises a carbonate-based polyurethane resin and a nonionic HDI type polyurethane-acrylate resin.

14. The coated substrate of aspect 13, wherein the substrate comprises a substrate formed from the group consisting of polycarbonate, polycarbonate+acrylonitrile/butadiene/styrene copolymer, polycarbonate+carbon fiber, or polycarbonate+glass fiber.

15. The coated substrate of aspect 13 or 14, wherein the substrate is a substrate useful for a vehicle display screen, a PET protective film of mobile phones and a display for computers.

16. The coated substrate of any one of aspects 13 to 15, wherein the water-borne UV curable single-layer coating composition is the coating composition of any one of aspects 1 to 10.

### EXAMPLES

The following examples are provided to illustrate the invention, which, however, are not to be considered as limiting the invention to their details. Unless otherwise indicated, all parts and percentages in the following examples, as well as throughout the specification, are by weight.

### Preparation Examples

Example 1 Preparation of the inventive water-borne coating composition and a coat formed with the same

63.4% of carbonate-based polyurethane (L-3685 from Hauthaway, USA) is charged into a main tank and a turbo-mixer is initiated to 500-1000 rpm. Then, 1.92% of a rheology modifier (AQUATIX 8421 from BYK), 0.38% of a dispersant (SOLSPERSE 20000), 0.48% of a defoamer (BYK-024) and 1.44% of a photoinitiator (IRGACURE 2959) are added in order with stirring, and the resulting dispersion is mixed for 30 minutes. To the mixture are then added 21.13% of a polyurethane-acrylate resin (OLESTER RA7011), 1.44% of a wetting agent (TEGO TWIN 4100), 0.96% of a photoinitiator (IRGACURE 819DW), 4.8% of water, and 2.89% of 2-butoxyethanol as a cosolvent, and the mixture is mixed for 10 minutes. 0.1% of dimethylethanolamine and 0.1% of water are premixed and added to the main tank with stirring. 0.96% of a rheology modifier (AQUATIX 8421) is added to the main tank to yield a semi-finished product. 100 parts of the semi-finished product is mixed with one part of a pigment PSM BLACK C (available from Mikuni Color Ltd.) to yield a black water-borne UV curable coating. It is applied to a PC substrate by using an air spraying process, baked at 60° C. for 10 minutes, and irradiated via an UV mercury lamp (700-900 mJ/cm², 100-300 mW/cm²), to produce a dry film having a thickness of 15-20 μm.

Example 2 Preparation of the inventive water-borne coating composition and a coat formed with the same

A semi-finished product is prepared as described in Example 1. 100 parts of the semi-finished product is mixed with one part of a pigment PSM BLACK C (available from Mikuni Color Ltd.) and 1 part of mica powder (XIRALLIC T60-23 RII GALAXY BLUE from Merck) to yield a black water-borne UV curable coating having a pearl effect. It is applied to a PC substrate by using an air spraying process, baked at 60° C. for 10 minutes, and irradiated via an UV mercury lamp (700-900 mJ/cm², 100-300 mW/cm²), to produce a dry film having a thickness of 15-20 μm.

Example 3 Preparation of the inventive water-borne coating composition and a coat formed with the same

This example is the same as Example 1 except that amounts of the photoinitiators (IRGACURE 2959 and IRGACURE 819DW) are reduced to 0.72% and 0.48%, respectively.

Example 4 Preparation of the inventive water-borne coating composition and a coat formed with the same

This example is the same as Example 2 except that the amount of mica powder is increased to 2%.

The resultant coating compositions from the Examples 1 to 4 have the VOC content of about 161 g/L (calculated without water). The VOC content is determined as follows:

1. measuring the mass of each compound i in the composition m₁, the mass of water in the composition m_{w}, the density of the composition pₛ, respectively;

2 calculating the VOC contents in accordance with the equations below:

$${ρ ( VOC )}_{lw} = ( \frac{{\sum }_{i = 1}^{i = n} {m}_{i}}{1 - {ρ}_{s} \times \frac{{m}_{w}}{{ρ}_{w}}} ) \times {ρ}_{s} \times 1000$$

wherein p_{w} is the density of water at 23° C.

Then, the substrates coated with the low VOC water-borne UV curable single-layer coating compositions of the present invention are tested for properties as follows. Results are shown in Table 1 below.

Testing items

1. Adhesion Test on a PC Substrate

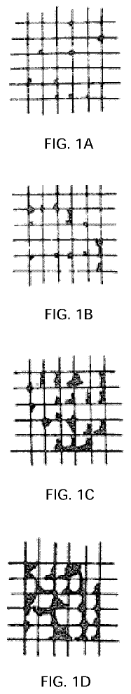

A sharp blade (blade point angle: 20°-30°, blade thickness: 0.43±0.03 mm) is used to cut 10×10 lattices in 1 mm×1 mm on the surface of a test sample, and chips on the test region are wiped out using a brush. A tape with an adhesive force of 10±1 N/25 mm (NICHIBAN CT405AP-24 tape) firmly sticks to the lattices to be tested, and then it is pressed with nails to expel bubbles between the tape and the coating to increase contacting area and intensity between the tape and the region to be tested (nails should not destroy the tape). After keeping 90±30 s, the tape is seized with a hand at one end and torn in 0.5-1 second in the direction opposite to a 60° angle. The test is conducted once. After testing, the paint film is examined for peeling by using a 5X magnifier. Criteria is shown below (FIGS. 1A-1D show schematic illustrations of peeling of the coating after being subjected to adhesion test on PC substrates)

| Rating | Description | Schematic Peeling |
|---|---|---|
| 5B | Smooth cutting edges, no peeling | |
| 4B | A little coating peeling present at | See Figure 1A |
| | intersections of incisions, but not | |
| | more than 5% of cross-cutting | |
| | area being affected | |
| 3B | Coating peeling present at | See Figure 1B |
| | intersections of incisions or along | |
| | edges of incisions, more than 5%, | |
| | but not more than 15% of cross- | |
| | cutting area being affected | |
| 2B | Part or all of coating peeling in | See Figure 1C |
| | large fragments along edges of | |
| | cutting, and/or from different | |
| | portions of lattices, more than | |
| | 15%, but not more than 35% of | |
| | cross-cutting area being affected | |
| 1B | Coating peeling in large fragments | See Figure 1D |
| | along edges of cutting, and/or | |
| | some lattices peeling as whole, | |
| | more than 35%, but not more | |
| | than 65% of cross-cutting area | |
| | being affected | |
| 0B | peeling extent beyond 1B | |

4B and 5B are considered as passing the test.

2. Abrasion Resistance Test

An exclusive NORMAN RCA Abrasion Resistance tester and an exclusive tape (width 11/16 inch×6) manufactured by NORMAN are used with an applied load of 175 g. The tape on the surface of the specimen is continuously rubbed for given cycles.

The substrate should not be exposed after rubbing. The testing was evaluated as passing if the substrate was not exposed after rubbing for 150 cycles.

3. Appearance Test after Water-boiling

A specimen coated with the present coating composition is cured, placed into water at 80° C. for 1 hr, and then taken out. The specimen would be considered as passing the test if there is no abnormality such as bubbles and cracking for appearance.

4. Adhesion Test after Water-boiling

A specimen coated with the present coating composition is cured, placed into water at 80° C. for 1 hr, and then taken out. The specimen is hold at room temperature for 1 hr and tested for adhesion according to procedures as described in 1. It would be considered as passing the test if 4B and 5B are achieved.

5. Adhesion Test after Recoating

A specimen that has been coated with the present coating composition and cured is coated again (“recoated”) with the present coating composition and cured in the same manner. The specimen is tested for adhesion according to procedures as described in 1. It would be considered as passing the test if 4B and 5B are achieved.

TABLE 1
Test Results Comparisons

| | Example 1 | Example 2 | Example 3 | Example 4 |
|---|---|---|---|---|
| Adhesion on PC | 5B | 5B | 5B | 5B |
| substrates | | | | |
| Abrasion Resistance, | >150 | >150 | >150 | >150 |
| tape-rubbing, | cycles | cycles | cycles | cycles |
| unexposed substrate | | | | |
| Appearance after | Normal | Normal | Normal | Normal |
| Water-boiling | | | | |
| Adhesion after | 4-5B | 4-5B | 4-5B | 4-5B |
| Water-boiling | | | | |
| Adhesion after | 4-5B | 4-5B | 4-5B | 4-5B |
| Recoating | | | | |

Whereas particular embodiments of this invention have been described above for purposes of illustration, it will be evident to those skilled in the art that numerous variations of the details of the present invention may be made without departing from the invention as defined in the appended claims.

1. A water-borne UV curable single-layer coating composition, comprising a carbonate-based polyurethane resin and a nonionic HDI type polyurethane-acrylate resin.

2. The water-borne UV curable single-layer coating composition of claim 1, wherein the carbonate-based polyurethane resin comprises 45-65 wt % polycarbonate in the carbonate-based polyurethane resin.

3. The water-borne UV curable single-layer coating composition of claim 1, wherein the carbonate-based polyurethane resin has a viscosity of about 50 to 500 cp at a temperature of 25° C.

4. The water-borne UV curable single-layer coating composition of claim 1, wherein the carbonate-based polyurethane resin comprises 20-25 wt % of the total weight of the coating composition.

5. The water-borne UV curable single-layer coating composition of claim 1, wherein the nonionic HDI type polyurethane-acrylate resin comprises 48-67 wt % of acrylate compounds in the nonionic HDI type polyurethane-acrylate resin.

6. The water-borne UV curable single-layer coating composition of claim 1, wherein the nonionic HDI type polyurethane-acrylate resin has a weight average molecular weight of from about 500 to 4000.

7. The water-borne UV curable single-layer coating composition of claim 1, wherein the nonionic HDI type polyurethane-acrylate resin has a glass transition temperature of from about 120 to 180° C.

8. The water-borne UV curable single-layer coating composition of claim 1, wherein the nonionic HDI type polyurethane-acrylate resin comprises 10-15 wt % of the total weight of the coating compostion.

9. The water-borne UV curable single-layer coating composition of any of the preceding claims, having a VOC content of less than 420 g/L.

10. The water-borne UV curable single-layer coating composition of claim 9, having a VOC content in the range of 100-250 g/L.

11. A method for forming a coating on a substrate, comprising applying a water-borne UV curable single-layer coating composition to at least a portion of the substrate, wherein the water-borne UV curable single-layer coating composition comprises a carbonate-based polyurethane resin and a nonionic HDI type polyurethane-acrylate resin.

12. A coated substrate, comprising a substrate and a water-borne UV curable single-layer coating composition deposited on at least a portion of the substrate, wherein the water-borne UV curable single-layer coating composition comprises a carbonate-based polyurethane resin and a nonionic HDI type polyurethane-acrylate resin.

13. The coated substrate of claim 12, wherein the substrate comprises a substrate formed from the group consisting of polycarbonate, polycarbonate+acrylonitrile/butadiene/styrene copolymer, polycarbonate+carbon fiber, or polycarbonate+glass fiber.

14. The coated substrate of claim 12 or 13, wherein the substrate is a substrate useful for a vehicle display screen, a PET protective film of mobile phones and a display for computers.
